(19) United States
(12) Patent Application Publication
(10) Pub. No.: US 2024/0153676 A1
(43) Pub. Date: May 9, 2024

(54) GROMMET UNIT AND WIRE HARNESS

(71) Applicant: SUMITOMO WIRING SYSTEMS, LTD., Mie (JP)

(72) Inventor: Taiki KOBAYASHI, Mie (JP)

(21) Appl. No.: 18/279,855

(22) PCT Filed: Mar. 3, 2022
(86) PCT No.: PCT/JP2022/009121

§ 371 Date: Aug. 31, 2023

(30) Foreign Application Priority Data
Mar. 5, 2021 (JP) 2021-035532

(51) Int. Cl. H01B 17/58; F16L 5/10

(52) U.S. Cl. CPC H01B 17/583; F16L 5/10; H02G 3/22

(57) ABSTRACT

A grommet unit includes: a grommet and a bracket. The attaching portion of the grommet includes: a flange portion extending from the main body portion so as to intersect with an insertion direction, and a plurality of projections projecting from the flange portion toward the bracket so as to intersect with the flange portion. The bracket has holes through which the projections are respectively passed. Each of the projection includes, in an order from the flange portion toward a leading end: a base end portion that is at least partially received in the corresponding hole; an intermediate portion that is greater in thickness than the base end portion and is greater in dimension than the hole, and a leading end portion that is smaller in dimension than the hole.

### TECHNICAL FIELD

The present disclosure relates to a grommet unit and a wire harness.

### BACKGROUND

Patent Document 1 discloses a technique for fixing a grommet to a body panel using a bracket. In the grommet unit disclosed in Patent Document 1, the bracket is mounted by being fitted into a lock recess formed in an outer surface of a retaining portion of the grommet over the entire circumference.

### PRIOR ART DOCUMENT

### Patent Document

Patent Document 1: JP 2020-074671 A

### SUMMARY OF THE INVENTION

### Problems to be Solved

In the grommet unit disclosed in Patent Document 1, when mounting the bracket to the grommet, it is necessary to deform a flange portion. There is a demand for improving the operability of an operation of mounting a bracket to a grommet.

Therefore, an object is to provide a technique for achieving an improvement in operability of an operation of mounting a bracket to a grommet.

### Means to Solve the Problem

The grommet unit according to the present disclosure is directed to a grommet unit including: a grommet including a main body portion that is tubular and into which a wire is to be inserted, and an attaching portion for use in attaching to a target for attachment; and a bracket that covers the attaching portion from one side, and fixes the attaching portion to the target for attachment, wherein the attaching portion includes: a flange portion extending from the main body portion so as to intersect with an insertion direction, and a plurality of projections projecting from the flange portion to the one side so as to intersect with the flange portion, the bracket has holes through which the projections are respectively passed, each of the projection includes, in an order from the flange portion toward a leading end: a base end portion that is at least partially received in the corresponding hole; an intermediate portion that is greater in thickness than the base end portion and is greater in dimension than the hole, and a leading end portion that is smaller in dimension than the hole, and recessed portions are formed in the attaching portion, each of the recessed portions having an opening in the flange portion on a side opposite to the corresponding projection, and being recessed from the opening to at least part of the base end portion.

### Effect of the Invention

According to the present disclosure, it is possible to achieve an improvement in operability of an operation of mounting a bracket to a grommet.

### BRIEF DESCRIPTION OF THE DRAWINGS

FIG. 1 is a plan view illustrating a grommet unit according to Embodiment 1.

FIG. 2 is a cross-sectional view taken along a line II-II in FIG. 1.

FIG. 3 is a perspective view illustrating a grommet.

FIG. 4 is a bottom view illustrating the grommet.

FIG. 5 is an enlarged view of a region A in FIG. 2.

FIG. 6 is a diagram illustrating how a bracket is mounted to the grommet.

FIG. 7 is a diagram illustrating how the bracket is mounted to the grommet.

FIG. 8 is a diagram illustrating how the bracket is subjected to a force when it is pulled out from the grommet.

FIG. 9 is a diagram illustrating how the bracket is subjected to a force when it is pulled out from the grommet.

### DETAILED DESCRIPTION TO EXECUTE THE INVENTION

### Description of Embodiments

First, modes for carrying out the present disclosure will be listed and described.

The grommet unit and a wire harness according to the present disclosure are as follows.

(1) A grommet unit includes: a grommet including a main body portion that is tubular and into which a wire is to be inserted, and an attaching portion for use in attaching to a target for attachment; and a bracket that covers the attaching portion from one side, and fixes the attaching portion to the target for attachment, wherein the attaching portion includes: a flange portion extending from the main body portion so as to intersect with an insertion direction, and a plurality of projections projecting from the flange portion to the one side so as to intersect with the flange portion, the bracket has holes through which the projections are respectively passed, each of the projection includes, in an order from the flange portion toward a leading end: a base end portion that is at least partially received in the corresponding hole; an intermediate portion that is greater in thickness than the base end portion and is greater in dimension than the hole, and a leading end portion that is smaller in dimension than the hole, and recessed portions are formed in the attaching portion, each of the recessed portions having an opening in the flange portion on a side opposite to the corresponding projection, and being recessed from the opening to at least part of the base end portion. Due to the recessed portions formed in the attaching portion, the projections deform easily when the projections are inserted into the respective holes, making the insertion of the projections into the respective holes easy. With this, it is possible to achieve an improvement in operability of an operation of mounting the bracket to the grommet.

(2) In the grommet unit according to the item (1), preferably, each of the recessed portions is recessed from the opening to at least part of the intermediate portion. With this, the projection deforms more easily when it is inserted into the corresponding hole.

(3) In the grommet unit according to the item (1) or (2), preferably, the leading end portion is solid. With this, when the projection that is inserted into the hole is subjected to a force in a direction in which it is pulled out from the hole, the projection is likely to keep its shape, making it possible to achieve an improvement in performance of retaining the projection in the hole.

(4) In the grommet unit according to any one of the items (1) to (3), preferably, the intermediate portion has a thickest portion that has the greatest thickness, and the projection is tapered from the thickest portion toward the leading end portion. With this, it is easy to insert the leading end portion of the projection into the corresponding hole.

(5) In the grommet unit according to the item (4), preferably, the thickest portion has a thickness that is 1.2 to 3 times as large as the dimension of the hole. Due to the thickness of the thickest portion being equal to or smaller than the three-fold of the dimension of the hole, it is possible to suppress such a situation that the projection is inserted into the corresponding hole with difficulties. Also, due to the thickness of the thickest portion being equal to or greater than the 1.2 fold of the dimension of the hole, the projection that is inserted into the corresponding hole is not likely to be removed from the hole.

(6) In the grommet unit according to any one of the items (1) to (5), preferably, the attaching portion further includes a lip portion that protrudes from a face of the flange portion in which the openings of the recessed portions are formed, the lip portion being capable of coming into intimate contact with a circumferential portion of an insertion hole in the target for attachment, and the recessed portions are formed between the main body portion and the lip portion.

(7) Also, a wire harness according to the present disclosure is directed to a wire harness that includes: the grommet unit according to any one of the items (1) to (6), and a wire that is inserted into the main body portion of the grommet. Due to the recessed portions formed in the attaching portion, the projections deform easily when the projections are inserted into the respective holes, making the insertion of the projections into the respective holes easy. With this, it is possible to achieve an improvement in operability of an operation of mounting the bracket to the grommet.

### DETAILS OF EMBODIMENTS OF THE PRESENT DISCLOSURE

The following will describe specific examples of the grommet unit and wire harness of the present disclosure with reference to the drawings. Note that the present disclosure is not limited to the examples but is defined by the claims, and all modifications within the meaning and scope equivalent to the claims are intended to be included.

### Embodiment 1

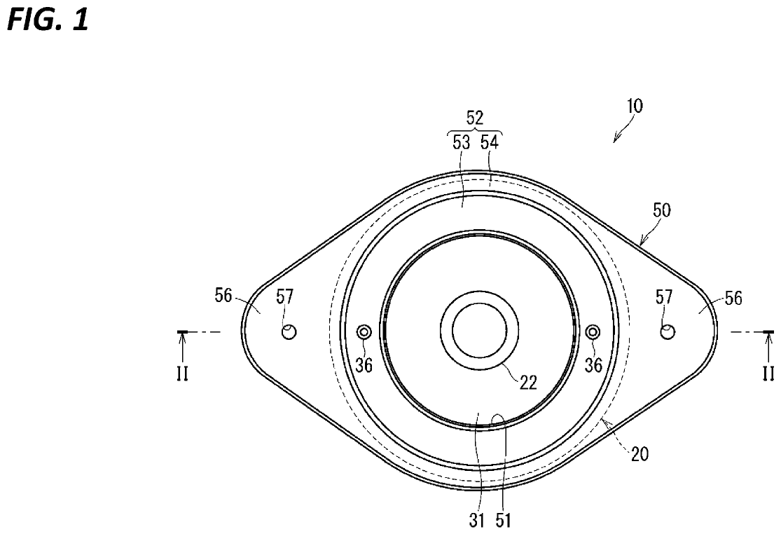

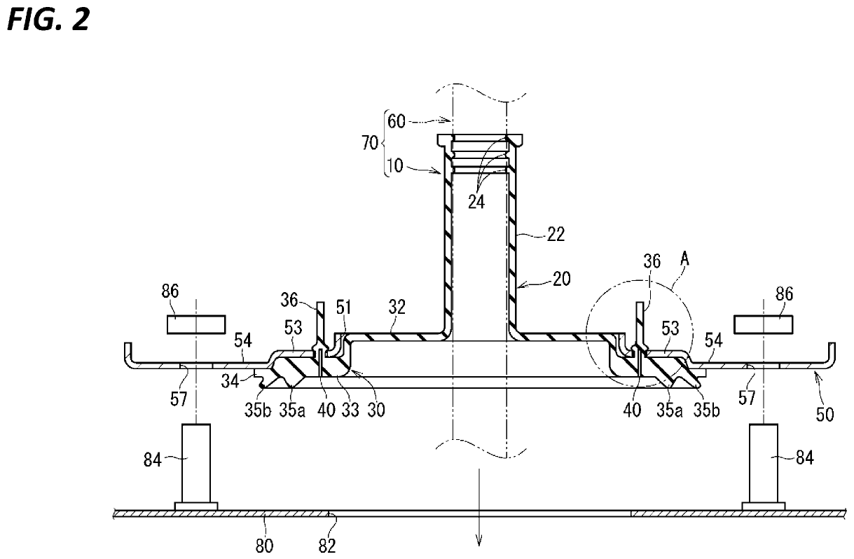

The following will describe a grommet unit and wire harness according to Embodiment 1. FIG. 1 is a plan view illustrating the grommet unit according to Embodiment 1. FIG. 2 is a cross-sectional view taken along a line II-II in FIG. 1.

The grommet unit includes a grommet and a bracket. A grommet 20 is to be attached to a target for attachment via a bracket. The target for attachment is preferably a member for partitioning a space of a vehicle. Hereinafter, description is given assuming that the target for attachment is a vehicle body panel 80. For example, the vehicle body panel 80 may be a panel (such as, for example, a floor panel) that separates the interior space of the vehicle from the exterior space. Also, for example, the vehicle body panel 80 may be a panel for dividing the interior space of the vehicle into a plurality of spaces (such as, for example, a dash panel separating the passenger compartment from the front compartment).

The vehicle body panel 80 has an insertion hole 82 passing through the vehicle body panel 80. A wire 60 is passed through the insertion hole 82. With this, the wire 60 is arranged so as to extend from one to the other of two spaces separated by the vehicle body panel 80. The grommet 20 prevents water from entering the insertion hole 82 and protects the wire 60. Specifically, the grommet 20 separates, together with the vehicle body panel 80, two spaces from each other in the vicinity of the insertion hole 82. The grommet 20 prevents water, dirt, and the like from entering, via the insertion hole 82, one from the other of the two spaces separated by the vehicle body panel 80. The grommet 20 protects the wire 60 from a member arranged in a rim portion of the insertion hole 82 in the vehicle body panel 80 or in the vicinity of the insertion hole 82.

In the present disclosure, as shown in FIG. 2, among an X-direction, a Y-direction, and a Z-direction that are orthogonal to each other, the X-direction is defined as a direction parallel to a thickness direction of the vehicle body panel 80 (axial direction of the insertion hole 82). The surface of the vehicle body panel 80 in the vicinity of the opening of the insertion hole 82 is a planar surface parallel to a YZ plane. When the grommet 20 in a non-attached state is described, directions that correspond to the X-direction, the Y-direction, and the Z-direction when the grommet 20 is in an attached state are used for the description.

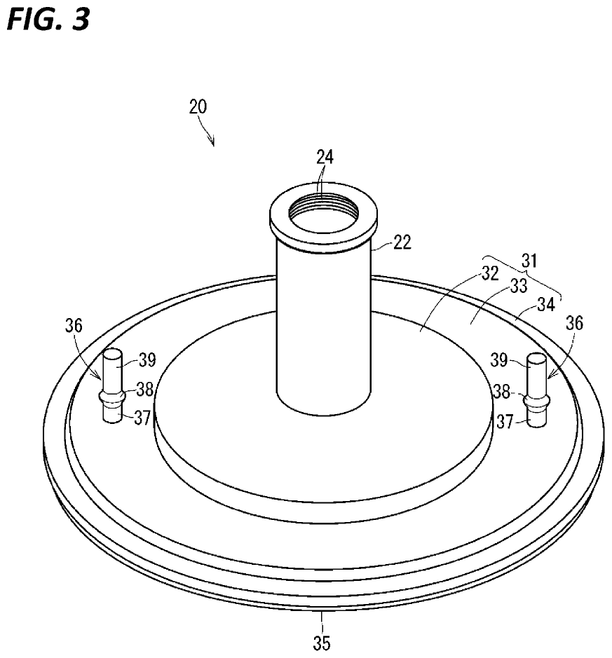

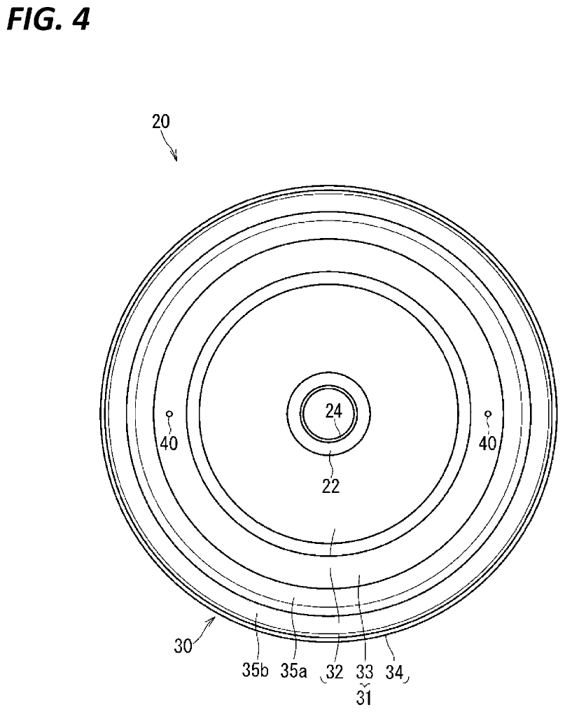

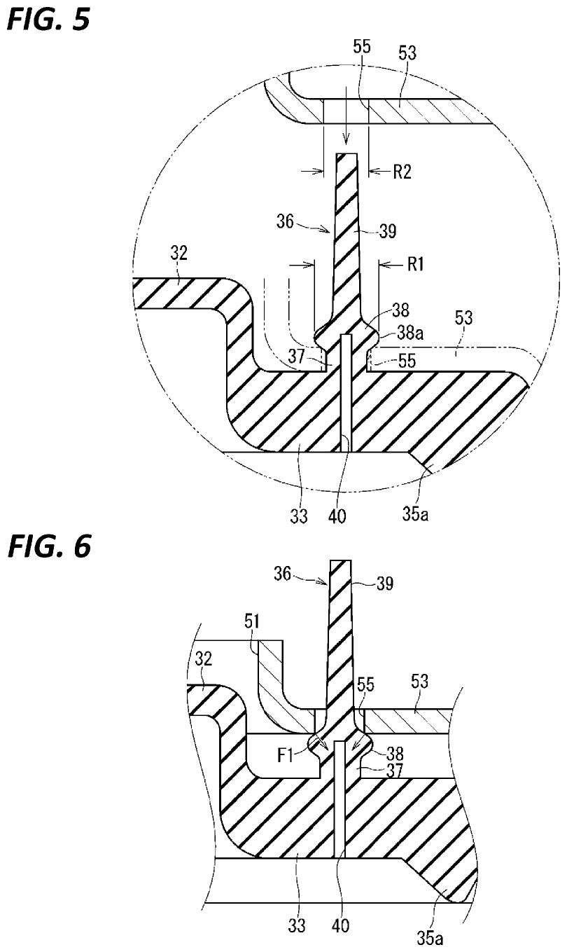

The following describes components of the grommet unit 10 with reference to FIGS. 1 and 2, as well as FIGS. 3 to 5. FIG. 3 is a perspective view illustrating the grommet 20. FIG. 4 is a bottom view illustrating the grommet 20. FIG. 5 is an enlarged view of a region A in FIG. 2.

<Grommet>

The grommet 20 includes a main body portion 22 and an attaching portion 30. The grommet 20 is an integrally molded article obtained by integrally molding the main body portion 22 and the attaching portion 30. The grommet 20 is made of an elastic material. For example, elastomer such as highly elastic EPDM (ethylene-propylene-diene rubber) can be used as the material of the grommet 20. The grommet 20 may be integrally die-molded with an elastic material as described above.

The main body portion 22 is a portion through which the wire 60 is passed. The main body portion 22 is tubular. Here, the wire 60 is inserted into the grommet 20 in a direction parallel to the X-direction. The direction in which the wire 60 is inserted into the grommet 20 may intersect with the X-direction at an angle other than the orthogonal angle.

The main body portion 22 holds the wire 60. The main body portion 22 is tubular. The horizontal cross sections of the inner and outer surfaces of the main body portion 22 are circular. The main body portion 22 is continuous in the X-direction with the same inner diameter. The mode in which the main body portion 22 holds the wire 60 is not particularly limited, and can be set as appropriate. For example, the wire 60 that is inserted into the main body portion 22 may be held by winding tape around the main body portion 22 and the wire 60 extending from the main body portion 22. Also, for example, the wire 60 that is inserted into the main body portion 22 may be held by crimping an outer circumferential portion of the main body portion 22 with a crimping member. Also, for example, the inner surface of the main body portion 22 may have a dimension equal to or smaller than that of the wire 60, and the wire 60 may be held by being fastened by the elasticity of the main body portion 22 itself.

It is preferable that the inside of the main body portion 22 be water-proofed with the wire 60 inserted into the main body portion 22. Here, a lip portion 24 is provided for enhancing the water-proofing performance of the inside of the main body portion 22. The lip portion 24 protrudes from the inner surface of the main body portion 22 toward the inner space of the main body portion 22. The lip portion 24 can come into contact with the wire 60 inserted into the main body portion 22. The lip portion 24 is formed as a closed ring on the inner surface of the main body portion 22. As a result of the lip portion 24 and the wire 60 coming into intimate contact with each other over the entirety in a circumferential direction, the water-proofing performance of the inside of the main body portion 22 is enhanced. In the present example, three lip portions 24 are provided. The three lip portions 24 are provided at intervals in the X-direction. However, the number of the lip portions 24 may be one or two, or four or more.

The attaching portion 30 is a portion for use in attaching to a target for attachment (here, the vehicle body panel 80). The attaching portion 30 extend from the main body portion 22 in a direction that intersects with the insertion direction. The attaching portion 30 includes a flange portion 31, a lip portion 35, and projections 36. The projections 36 are provided on the surface of the flange portion 31 that faces the main body portion 22 (the positive side in the X-direction). The bracket 50 is arranged to oppose this surface. The flange portion 31 of the attaching portion 30 is interposed between the vehicle body panel 80 and the bracket 50. Also, the surface of the flange portion 31 that is opposite to the surface facing the main body portion 22 (the positive side in the X-direction) is a surface facing the vehicle body panel 80. The lip portion 35 is provided on this surface.

The flange portion 31 extends from an end of the main body portion 22 so as to intersect with the insertion direction. As the flange portion 31, a first flange portion 32, a second flange portion 33, and a third flange portion 34 are provided. The outer edges of the first flange portion 32, the second flange portion 33, and the third flange portion 34 are circular. The first flange portion 32 is joined to the end of the main body portion 22. The second flange portion 33 is provided on the outer circumferential side of the first flange portion 32. The third flange portion 34 is provided on the outer circumferential side of the second flange portion 33. The second flange portion 33 and the third flange portion 34 are interposed between the vehicle body panel 80 and the bracket 50.

The surface of the first flange portion 32 that faces the main body portion 22 (the positive side in the X-direction) and the surface of the second flange portion 33 that faces the main body portion 22 (the positive side in the X-direction) are shifted in the X-direction. Therefore, there is a level difference between the surface of the first flange portion 32 that faces the main body portion 22 (the positive side in the X-direction) and the surface of the second flange portion 33 that faces the main body portion 22 (the positive side in the X-direction). The surface of the second flange portion 33 that faces the main body portion 22 (the positive side in the X-direction) and the surface of the third flange portion 34 that faces the main body portion 22 (the positive side in the X-direction) are shifted in the X-direction. Therefore, there is a level difference between the surface of the second flange portion 33 that faces the main body portion 22 (the positive side in the X-direction) and the surface of the third flange portion 34 that faces the main body portion 22 (the positive side in the X-direction). Due to the level difference between the first flange portion 32 and the second flange portion 33, and the level difference between the second flange portion 33 and the third flange portion 34, positioning of the grommet 20 and the bracket 50 is easy. Furthermore, due to the level difference between the second flange portion 33 and the third flange portion 34, it is easy to realize a more appropriate sealing pressure.

The first flange portion 32 and the second flange portion 33 have different thicknesses. The second flange portion 33 and the third flange portion 34 have different thicknesses. The thickness of second flange portion 33 is greater than the thickness of the first flange portion 32 and the thickness of the third flange portion 34. Also, the thickness of the second flange portion 33 is greater than the thickness of the main body portion 22. However, the thicknesses of the components of the grommet 20 are not limited to those, and can be set as appropriate.

The lip portion 35 realizes water-proofing between the grommet 20 and the vehicle body panel 80. The lip portion 35 is annular. The lip portion 35 can come into intimate contact with the vehicle body panel 80 while surrounding the entire circumference of the opening of the insertion hole 82. In the present example, two lip portions 35 are provided. Of two lip portions 35a and 35b, the lip portion 35a is located on the inner circumferential side, and the lip portion 35b is located on the outer circumferential side. Therefore, the diameter of the lip portion 35b is larger than that of the lip portion 35a. The two lip portions 35 are provided near the level difference between the second flange portion 33 and the third flange portion 34. The lip portion 35a is provided on the second flange portion 33, and the lip portion 35b extends over the boundary between the second flange portion 33 and the third flange portion 34.

The projections 36 project from the flange portion 31 (here, the second flange portion 33) in the X-direction so as to intersect with the flange portion 31. Each of the projection 36 includes a base end portion 37, an intermediate portion 38, and a leading end portion 39. The base end portion 37 is a portion joined to the flange portion 31. The base end portion 37 extends from the flange portion 31 toward the leading end. The intermediate portion 38 and the leading end portion 39 are provided on the leading end side with respect to the base end portion 37. The intermediate portion 38 is joined to the base end portion 37. The intermediate portion 38 is thicker than the base end portion 37 and the leading end portion 39. The leading end portion 39 is joined to the intermediate portion 38. For example, an operator can, while holding the leading end portion 39, insert and lock the projection 36 into the corresponding lock hole 55. The leading end portion 39 is longer than the base end portion 37 and the intermediate portion 38.

The intermediate portion 38 has a thickest portion 38a that has the greatest thickness. The projection 36 is tapered from the thickest portion 38a toward the leading end portion 39. The intermediate portion 38 is gradually tapered from the thickest portion 38a to the leading end portion 39 side with respect to the thickest portion 38a. The leading end portion 39 is gradually tapered from the intermediate portion 38 toward the leading end as a whole. The outer surface of the leading end portion 39 is inclined at a constant inclination angle. The inclination of the portion between the thickest portion 38a of the intermediate portion 38 and the leading end portion 39 is steeper than the inclination of the leading end portion 39. The intermediate portion 38 gradually increases in its thickness from the base end portion 37 side with respect to the thickest portion 38a toward the thickest portion 38a.

Recessed portions 40 are formed in the attaching portion 30. Each of the recessed portions 40 has an opening in the flange portion 31 on a side opposite to the corresponding projection 36. The recessed portion 40 has the opening in the face of the flange portion 31 on which the lip portion 35 is provided. The recessed portion 40 is provided between the main body portion 22 and the lip portion 35. The recessed portion 40 is recessed from this opening to at least part of the base end portion 37. The recessed portion 40 may be recessed from this opening to at least part of the intermediate portion 38. Here, the recessed portion 40 is recessed from this opening to part of the intermediate portion 38. Accordingly, here, the remaining part of the intermediate portion 38 and the leading end portion 39 are solid (filled state without any cavity). The recessed portion 40 is not open to the surface of the projection 36. Accordingly, water is prevented from passing through the grommet 20 via the recessed portion 40.

<Bracket>

The bracket 50 covers the attaching portion 30 from one side and fixes the attaching portion 30 to the vehicle body panel 80. The bracket 50 includes a bracket main body 52 and a fixing portion 56. By, for example, bending and pressing a metal plate material, the bracket 50 is shaped to have the bracket main body 52 and the fixing portion 56.

The bracket main body 52 is in surface contact with the flange portion 31 in the thickness direction. The bracket main body 52 can press the flange portion 31 toward a portion surrounding the insertion hole 82 in the vehicle body panel 80. The bracket main body 52 is annular. The bracket main body 52 has a through hole 51 through which the main body portion 22 of the grommet 20 is passed. The diameter of the through hole 51 is equal to or greater than (here, slightly greater than) that of the first flange portion 32. The first flange portion 32 is passed through the through hole 51. With this, the grommet 20 and the bracket 50 are positioned. The bracket main body 52 is in surface contact with the second flange portion 33 and the third flange portion 34. The bracket main body 52 includes a first portion 53 and a second portion 54. The first portion 53 has a shape that corresponds to the second flange portion 33. The first portion 53 is in surface contact with the second flange portion 33. The second portion 54 has a shape that corresponds to the third flange portion 34. The second portion 54 is in surface contact with the third flange portion 34. Between the first portion 53 and the second portion 54, a level difference is provided that corresponds to the level difference between the second flange portion 33 and the third flange portion 34.

The fixation portion 56 is used for fixation to the vehicle body panel 80. The fixing portion 56 is provided at a position apart from the insertion hole 82 to the outer circumferential side, and can be fixed to the vehicle body panel 80 partially along the circumferential direction. The fixing portion 56 extends radially outward from part of the outer edge of the bracket main body 52. In the present example, a pair of fixing portions 56 are provided at an interval of 180 degrees. Three or more fixing portions may also be provided. Three or more fixing portions may be provided at an equal interval in the circumferential direction. Also, each fixing portion 56 has a fixation hole 57 passing through the fixing portion 56. A bolt 84 fixed to the vehicle body panel 80 is passed through the fixation hole 57 and is fastened. Note that, in the example shown in FIG. 5, the head of the bolt 84 is fixed, by welding or the like, to the surface of the vehicle body panel 80 on which the bracket 50 is arranged. However, the fixation mode of the bolt 84 to the vehicle body panel 80 is not limited to this. For example, the bolt 84 may also be fixed so that the shaft of the bolt 84 is passed through the vehicle body panel 80.

The bracket 50 is arranged so that the flange portion 31 of the grommet 20 is held between the bracket main body 52 and the vehicle body panel 80. By engaging a nut 86 with the bolt 84 passed through the fixation hole 57, the bracket 50 is fixed to the vehicle body panel 80, and due to the fixation of the bracket 50 and the vehicle body panel 80, the grommet 20 is fixed to the vehicle body panel 80. The lip portions 35 of the grommet 20 thus fixed come into intimate contact with the vehicle body panel 80. With this, water-proofing is realized between the grommet 20 and the vehicle body panel 80.

The bracket 50 has a lock hole 55 as a hole through which the corresponding projection 36 is passed. The projection 36 and the lock hole 55 function as a temporal fixation portion for temporarily fixing the grommet 20 and the bracket 50 before the bracket 50 is fixed to the vehicle body panel 80.

The lock hole 55 is formed in the bracket main body 52 at a position corresponding to the projection 36. The lock hole 55 is a through hole passing through the bracket main body 52. The projection 36 passes through the lock hole 55. Before being fixed to the vehicle body panel 80, the projection 36 is inserted and locked into the lock hole 55, and the bracket 50 is held by the grommet 20. At least part of the base end portion 37 is received in the lock hole 55.

The leading end portion 39 is thinner than the lock hole 55. The leading end portion 39 can easily pass through the lock hole 55. The intermediate portion 38 is thicker than the lock hole 55. When passing through the lock hole 55, the intermediate portion 38 is compressed due to being subjected to a force from, for example, the rim portion and the inner surface of the lock hole 55, and elastically deforms. Due to the force from the bracket 50 decreasing after the intermediate portion 38 has passed through the lock hole 55, the intermediate portion 38 elastically recovers and is locked to the rim portion of the lock hole 55.

A plurality of pairs of projections 36 and lock holes 55 are provided. In the present example, two pairs of projections 36 and lock holes 55 are provided at an interval of 180 degrees. A configuration is also possible in which three or more pairs of projections 36 and lock holes 55 are provided. In this case, three or more pairs of projections 36 and lock holes 55 are preferably provided at an equal interval in the circumferential direction.

Also, the outer surfaces of the projections 36 and the inner surfaces of the lock holes 55 are circular. The outer surfaces of the projections 36 and the inner surfaces of the lock holes 55 may also have a shape other than a circular shape.

In FIG. 5, the bracket indicated by solid lines shows a state before it is mounted to the grommet, and the bracket indicated by virtual lines shows a state after it has been mounted to the grommet. A diameter R1 in FIG. 5 denotes the thickness of the thickest portion 38a. Also, a diameter R2 in FIG. 5 denotes the diameter of the lock hole 55. Here, the value of the diameter R1 is 1.2 to 3 times as large as the value of the diameter R2.

<Mounting Mode of Grommet and Bracket>

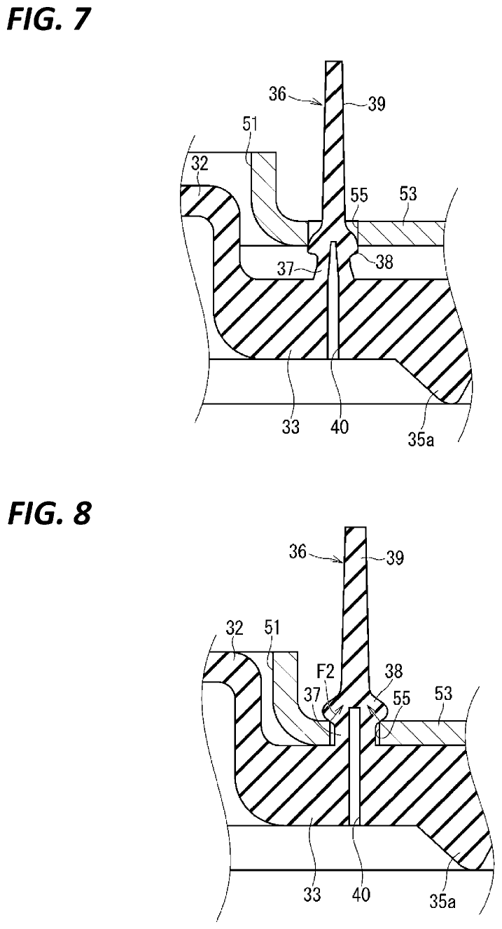

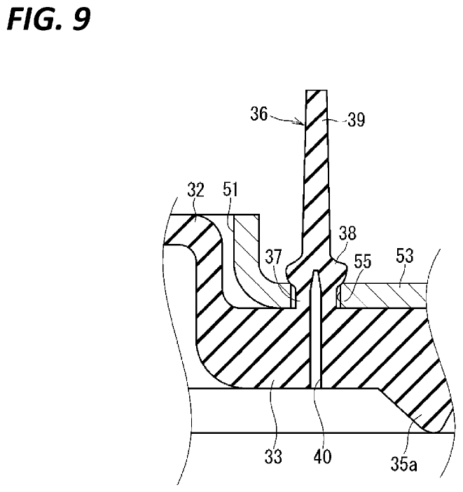

A mounting mode of the grommet 20 and the bracket 50 will be described with reference to FIGS. 6 to 9. FIGS. 6 and 7 are diagrams illustrating how the bracket 50 is mounted to the grommet 20. FIGS. 8 and 9 are diagrams illustrating modes in which the bracket 50 is subjected to a force when it is pulled out from the grommet 20.

When the bracket 50 is mounted to the grommet 20, the leading end portion 39 is first inserted into the lock hole 55. Then, when the portion of the leading end portion 39 adjacent to the intermediate portion 38 has been inserted into the lock hole 55, the intermediate portion 38 comes into contact with the rim portion of the opening of the lock hole 55. When the insertion is further continued, the intermediate portion 38 receives a force F1 from the rim portion of the opening of the lock hole 55, as shown in FIG. 6. Upon receiving the force F1, the intermediate portion 38 deforms so as to have a reduced diameter, as shown in FIG. 7. At this time, due to the recessed portion 40 formed to reach at least part of the base end portion 37, the base end portion 37 and the intermediate portion 38 can deform to reduce the dimension of the recessed portion 40. Also, the recessed portion 40 can be located at a position to which the force F1 is directed. With this, the intermediate portion 38 is likely to deform and reduce its diameter. Also, if the recessed portion 40 is formed to reach at least part of the intermediate portion 38, a large recessed portion 40 will be located at a position to which the force F1 is directed, and thus the intermediate portion 38 will be more likely to deform and reduce its diameter. With this, the intermediate portion 38 is likely to be inserted into the lock hole 55.

In a state in which the bracket 50 is mounted to the grommet 20, the rim portion of the lock hole 55 is located between the flange portion 31 and the intermediate portion 38. The rim portion of the lock hole 55 may come into intimate contact with both the flange portion 31 and the intermediate portion 38 when the entire base end portion 37 is received in the lock hole 55. With this, in the state in which the bracket 50 is mounted to the grommet 20, the bracket 50 and the grommet 20 are not likely to become shaky. A configuration is also possible in which only part of the base end portion 37 is received in the lock hole 55, and the rim portion of the lock hole 55 is in intimate contact with only one of the flange portion 31 and the intermediate portion 38.

As shown in FIG. 8, after the bracket 50 has been mounted to the grommet 20, the projection 36 may receive a force F2 when it is pulled out from the lock hole 55. In this case, as shown in FIG. 9, the intermediate portion 38 may deform and reduce its diameter. Also in this case, if the leading end portion 39 is solid, the force F2 applied to the projection 36 from the rim portion of the lock hole 55 can be received by the solid leading end portion 39. With this, the intermediate portion 38 is not likely to deform and reduce its diameter, and the projection 36 is not likely to be removed from the lock hole 55.

<Wire Harness>

As described above, the wire harness 70 is such that the grommet 20 of the grommet unit 10 is mounted to the wire 60. The wire harness 70 includes the above-described grommet unit 10 and the wire 60. The wire 60 is inserted into the grommet 20 and is held by the main body portion 22.

The wire 60 alone may be inserted into the grommet 20. In this case, the inner surface of the main body portion 22 is in contact with a coated portion of the wire 60. A configuration is also possible in which an exterior member is mounted to the outer circumferential portion of the wire 60, and the wire 60 is inserted together with the exterior member into the grommet 20. In this case, the inner surface of the main body portion 22 is at least partially in contact with the outer surface of the exterior member.

The exterior member is not particularly limited, and any exterior member may be used as long as it is insertable into the grommet 20 together with the wire 60. For example, the exterior member may be adhesive tape that bundles together a plurality of wires 60. Also, for example, the exterior member may be a tubular member such as a corrugated tube. Also, for example, the exterior member may be a sheet-shaped member wound around the wire 60.

Furthermore, one or more wires 60 may be inserted into the grommet 20. The wire 60 may be used for power supply or signaling. A low-voltage wire or a high-voltage wire may be used as a wire for power supply. For example, a single high-voltage wire 60 may be inserted into the grommet 20.

<Effects Etc.>

According to the grommet unit 10 having the above-described configuration, and the wire harness 70 including such a grommet unit 10, as a result of the recessed portions 40 being provided in the attaching portion 30, the projections 36 deform easily when the projections 36 are inserted into the respective lock holes 55, making the insertion of the projections 36 into the lock holes 55 easy. With this, it is possible to achieve an improvement in operability of an operation of mounting the bracket 50 to the grommet 20.

Also, each recessed portion is recessed from the opening on the flange portion 31 side to at least part of the intermediate portion 38. With this, when inserting the corresponding projection 36 into the lock hole 55, the projection 36 deforms more easily.

Also, the leading end portion 39 is solid. With this, when the projection 36 that is inserted into the lock hole 55 is subjected to a force in a direction in which it is pulled out from the lock hole 55, the projection 36 is likely to keep its shape, making it possible to achieve an improvement in performance of retaining the projection 36 in the lock hole 55.

Also, the intermediate portion 38 has a thickest portion 38a that has the greatest thickness, and the projection 36 is tapered from the thickest portion 38a toward the leading end portion 39. With this, it is easy to insert the leading end portion 39 of the projection 36 into the corresponding lock hole 55.

Also, the thickness of the thickest portion 38a is 1.2 to 3 times as large as the dimension of the lock hole 55. Due to the thickness of the thickest portion 38a being equal to or smaller than the three-fold of the dimension of the lock hole 55, it is possible to suppress such a situation that the projections 36 are inserted into the lock holes 55 with difficulties. Also, due to the thickness of the thickest portion 38a being equal to or greater than the 1.2 fold of the dimension of the lock hole 55, the projection 36 is not likely to be removed from the lock hole 55 in a state in which the projection 36 is inserted into and locked to lock hole 55.

Also, the attaching portion 30 further includes the lip portion 35 that protrudes from the face of the flange portion 31 in which the openings of the recessed portions 40 are formed, and can come into intimate contact with the circumferential portion of the insertion hole 82 in the vehicle body panel 80, and the recessed portions 40 are formed at positions between the lip portion 35 and the main body portion 22. With this, both the lip portion 35 and the openings of the recessed portions 40 are formed on/in the same face of the flange portion 31.

[Modifications]

Although a description has been given in which the recessed portion 40 is recessed from the opening on the flange portion 31 side to part of the intermediate portion 38, this is not an essential configuration. For example, a configuration is also possible in which the recessed portion is recessed over the entire intermediate portion 38 whereas the leading end portion 39 remains solid. Alternatively, for example, the recessed portion does not need to be recessed to the intermediate portion 38. The recessed portion may be recessed to part of the base end portion 37 or over the entire base end portion 37.

Although a description has been given in which the leading end portion 39 is solid, this is not an essential configuration. The leading end portion 39 is not necessarily solid. For example, the recessed portion may also be recessed to part of the leading end portion 39. Also, for example, the recessed portion may be a through hole that passes through the projection 36. Also, for example, the attaching portion may include a recessed portion that has an opening formed in the leading end portion 39, and is not joined to the recessed portion 40.

Furthermore, although a description has been given in which the projection 36 is tapered from the thickest portion 38a toward the leading end portion 39, this is not an essential configuration. For example, the leading end portion 39 is continuous with the same thickness.

Furthermore, although a description has been given in which the thickness of the thickest portion 38a is 1.2 to 3 times as large as the dimension of the lock hole 55, this is not an essential configuration. For example, the thickest portion 38a may also have a thickness smaller than the 1.2-hold of the dimension of the lock hole 55 as long as the thickness of the thickest portion 38a is greater than the dimension of the lock hole 55. Also, for example, the thickest portion 38a may have a thickness greater than the three-fold of the dimension of the lock hole 55.

Furthermore, although a description has been given in which the recessed portions 40 are provided between the main body portion 22 and the lip portion 35, this is not an essential configuration. For example, the lip portion 35 may also be provided between the main body portion 22 and the recessed portions 40.

Moreover, although an example has been given in which there is one main body portion 22, this is not an essential configuration. A configuration is also possible in which a single grommet 20 includes a plurality of main body portions 22. The plurality of main body portions 22 are provided at intervals in a direction (here, direction parallel to the YZ plane) that intersects with the insertion direction. The plurality of main body portions 22 may have the same shape. The plurality of main body portions 22 may also have different shapes. For example, the holding portion of a first main body portion may have an inner diameter that is greater than the inner diameter of the holding portion of a second main body portion. With this, for example, the dimension and the number of wires 60 to be inserted can be changed between the first main body portion and the second main body portion.

Although a description has been given in which the insertion hole 82 is circular, this is not an essential configuration. The insertion hole may have a shape other than a circular shape. For example, the insertion hole may be elliptical, oval, polygonal. Also, the attaching portion of the grommet may be elliptical, oval, polygonal, conforming to the shape of the insertion hole.

Note that the above-described embodiment and modifications can be freely combined unless they contradict each other.

### LIST OF REFERENCE NUMERALS

10 Grommet unit
20 Grommet
22 Main body portion
24 Lip portion
30 Attaching portion
31 Flange portion
32 First flange portion
33 Second flange portion
34 Third flange portion
35, 35a, 35b Lip portion
36 Projection
37 Base end portion
38 Intermediate portion
38a Thickest portion
39 Leading end portion
40 Recessed portion
50 Bracket
51 Through hole
52 Bracket main body
53 First portion
54 Second portion
55 Lock hole
56 Fixation portion
57 Fixation hole
60 Wire
70 Wire harness
80 Vehicle body panel (target for attachment)
82 Insertion hole
84 Bolt
86 Nut

1. A grommet unit comprising:
a grommet including a main body portion that is tubular and into which a wire is to be inserted, and an attaching portion for use in attaching to a target for attachment; and
a bracket that covers the attaching portion from one side, and fixes the attaching portion to the target for attachment,
wherein the attaching portion includes: a flange portion extending from the main body portion so as to intersect with an insertion direction, and a plurality of projections projecting from the flange portion to the one side so as to intersect with the flange portion,
the bracket has holes through which the projections are respectively passed,
each of the projection includes, in an order from the flange portion toward a leading end: a base end portion that is at least partially received in the corresponding hole; an intermediate portion that is greater in thickness than the base end portion and is greater in dimension than the hole, and a leading end portion that is smaller in dimension than the hole, and
recessed portions are formed in the attaching portion, each of the recessed portions having an opening in the flange portion on a side opposite to the corresponding projection, and being recessed from the opening to at least part of the base end portion.

2. The grommet unit according to claim 1,
wherein each of the recessed portions is recessed from the opening to at least part of the intermediate portion.

3. The grommet unit according to claim 1,
wherein the leading end portion is solid.

4. The grommet unit according to claim 1,
wherein the intermediate portion has a thickest portion that has the greatest thickness, and
the projection is tapered from the thickest portion toward the leading end portion.

5. The grommet unit according to claim 4,
wherein the thickest portion has a thickness that is 1.2 to 3 times as large as the dimension of the hole.

6. The grommet unit according to claim 1,
wherein the attaching portion further includes a lip portion that protrudes from a face of the flange portion in which the openings of the recessed portions are formed, the lip portion being capable of coming into intimate contact with a circumferential portion of an insertion hole in the target for attachment, and
the recessed portions are formed between the main body portion and the lip portion.

7. A wire harness comprising:
the grommet unit according to claim 1; and
a wire that is inserted into the main body portion of the grommet.
